(19) United States
(12) Patent Application Publication
(10) Pub. No.: US 2010/0215033 A1
(43) Pub. Date: Aug. 26, 2010

(54) PREFERENTIAL ROUTING OF SECURED CALLS

(75) Inventors: Michael J. Shaw, Columbia, MD (US); Kenneth Wnuck, Westminster, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/389,600

(22) Filed: Feb. 20, 2009

(51) Int. Cl. H04L 12/66; H04K 1/00

(52) U.S. Cl. 370/352; 380/257

(57) ABSTRACT

Installed in an IGAR gateway is intelligence for determining the capabilities of an endpoint. Many older generation secure phones are not IP capable and are thus not directly capable of operating in a VOIP environment. The intelligence allows backwards compatibility of IGAR to legacy phones by recognizing that the endpoint is not IP capable and forcing the secure connection to be routed over PSTN. IGAR could also be included between independent instances of a communications manager (CM). Currently IGAR is supported on only a single CM controlling PSTN gateways, and not between independent CMs. This embodiment recognizes that incoming PSTN call based on a DN and once answered, in-band digits are passed from the originating PBX to the destination PBX in order to route the call within the answering PBX.

### FIELD OF THE INVENTION

An exemplary embodiment of this invention relates to communications devices, protocols and techniques. More specifically, an exemplary aspect of this invention relates to secure communications, and routing thereof.

### BACKGROUND

Current Secure Terminal Equipment (STE) and STU-III are the Government's encrypted form of communications for landline voice applications. STU-III is a family of secure telephones introduced in 1987 by the NSA for use by the United States government, its contractors, and its allies. STU-III desk units look much like typical office telephones, plug into a standard telephone wall jack, and can make calls to any ordinary phone user (such calls receiving, however, no special protection). However, when a call is placed to another STU-III unit that is properly set up, one caller can ask the other to initiate secure transmission (or, colloquially, to “go secure”). They then press a button on their telephones and, after a delay, their call is encrypted to prevent eavesdropping. There are portable and militarized versions and most STU-IIIs contain an internal modem and RS-232 port for data and fax transmission.

Today these calls are routed over PSTN/ISDN facilities. In order to route these calls over an IP network, a very high QoS must be in place. When a STE or STU III voice call “goes secure” over a VoIP connection, a modem call is established between the near-end and the far-end units in order to exchange parameters to encrypt the voice or data conversation. Any delay, noise, or jitter on this connection will cause a retrain procedure impacting the voice quality of the encrypted call and possibly compromising the ability to secure the call.

In other systems, the processing of analog voice and digital information, including conversion of a voice signal to digital information (or digital information into a voice signal) and transmission of digital information representing voice data over a network is provided for secure transmission and secure receipt over a network, such as the Internet.

Other systems encapsulate standard telephone equipment information into IP packets in a remotely deployed, secure communication system. The IP packets are addressed to a matching IP encapsulator/de-encapsulator device over the public Internet or other IP protocol network, with a packet being passed to a similar STE device over an ISDN link for decryption.

Generally, in a single-server system with IP-WAN connected Port Network (PN) or H248 Media Gateway (MG), when a communications manager detects the inability to create IP Inter-Gateway Connection (IGC) between gateway (GW-1) in network region 1 (NR-1) and gateway (GW-2) in network region 2 (NR-2) for a station to station call, IGAR is constructed to route the call under any of following conditions:
The number of calls or bandwidth between NR-1 and NR-2 allocated via Call Admission Control-bandwidth Limits (CAC-BL) has been reached;
network performance deterioration is over threshold detected by dynamic-CAC;
VoIP RTP resources have been exhausted in GW-1 or GW-2;
a codec set is not specified between NR-1 and NR-2; or
forced IGAR between NR-1 and NR-2 is configured.

### SUMMARY

As discussed, for secure calls over an IP network, a very high QoS must be in existence with a modem call setup between the near-end and the far-end units in order to exchange parameters to encrypt the voice or data conversation. The IP packets are routed through an IGAR gateway once the call goes secure thereby allowing secure communications. However, secure IP-based communications require that the endpoints be IP-capable devices.

Details regarding IGAR gateways can be found in U.S. application Ser. No. 11/107,524, entitled “Alternate Routing Of Media Connections Within A Single Communications System Across Public Or Private Network Facilities,” and U.S. patent application Ser. No. 11/107,659, Entitled “In-Band Call Association Signaling For A Single Number Destination,” which are both incorporated herein by reference in their entirety.

In accordance with an exemplary embodiment of the present invention, IGAR is used in combination with an intelligent endpoint detection module to determine whether an endpoint is an IP endpoint, and then rerouting in mid-stream the secure call over a PSTN (traditional TDM) architecture in the event that the endpoint is not IP capable.

In accordance with one exemplary embodiment, installed in an IGAR gateway is intelligence for determining the capabilities of an endpoint. Many older generation secure phones are not IP capable and are thus not directly capable of operating in an IGAR environment. The intelligence allows backwards compatibility of IGAR to legacy phones by recognizing that the endpoint is not IP capable and forcing the secure connection to be routed over PSTN.

In another exemplary embodiment, IGAR is included between independent instances of a communications manager (CM). Currently IGAR is supported on a single CM controlling PSTN gateways, and not between independent CMs. This exemplary embodiment recognizes that incoming PSTN call based on a directory number and once answered, inband digits are passed from the originating PBX to the destination PBX in order to route the call within the answering PBX.

Additional aspects of the invention relate to IGAR signaling an inter-Port Network (PN) route via TDM on the same CM instance or between CM instances by using the endpoint capability determination module. So an inbound IGAR call will notify the CM during call setup or when an existing call “goes secure” that this is a secure call requiring TDM resources and not route the call over an IP network on the forward hops between port networks or gateways.

Exemplary aspects of this invention thus relate to communications management. More specifically, an exemplary aspect of this invention relates to secure communications management.

Additional aspects of the invention relate to including endpoint assessment intelligence in one or more IGAR gateways.

Still further aspects of the invention relate to determining endpoint capabilities when a call is requested to “go secure.”

Still further aspects of the invention relate to including IGAR between independent instances of a communication manager and managing secure communications between endpoints.

Additional aspects of the invention relate to an endpoint capability determination module that determines the capabilities of one or more endpoints.

Still further aspects of the invention relate to backward compatibility of IP-based communications architectures to non-IP enabled communications endpoints.

Additional aspects of the invention relate to backward compatibility of IGAR-based communications system to non-IP based telephones.

Still further aspects of the invention relate to managing call routing based on endpoint capabilities.

Even further aspects of the invention support 2 modes of operation for STEs:

autosecure where every off-hook will invoke IGAR, and

manual secure, where a voice call is already setup between STEs and a signal to the communications manager (new) or signal between (existing) STES already on the call via a manual button push referred to as “go secure.”

Additional aspects of the invention relate to backward compatibility of IGAR systems to analog telephones.

The present invention can provide a number of advantages depending on the particular configuration. These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like.

While circuit or packet-switched types of communications can be used with the present invention, the concepts and techniques disclosed herein are applicable to other protocols.

Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 illustrates an exemplary communications environment according to this invention;

FIG. 2 illustrates another exemplary communications environment according to this invention; and

FIG. 3 is a flowchart illustrating an exemplary method for routing communications according to this invention.

### DETAILED DESCRIPTION

The invention will be described below in relation to a communications environment. Although well-suited for use with circuit-switched and packet-switched networks, the invention is not limited to use with any particular type of communication system or configuration of system elements and those skilled in the art will recognize that the disclosed techniques may be used in any application in which it is desirable to provide secure communications between endpoints. While the various endpoints described herein can be any communications device, such as a telephone, speakerphone, cellular phone, SIP-enabled endpoint, soft phone, PDA, wired or wireless communication device, or in general any communications device that is capable of sending and/or receiving new voice communications, the endpoints will generally be secure-capable endpoints. These secure-capable endpoint may include a user-selectable button that, when pushed, indicates a user's desire to “go secure.”

The exemplary systems and methods of this invention will also be described in relation to software, modules and associated hardware and network(s). However, to avoid unnecessarily obscuring the present invention, the following description emits well known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

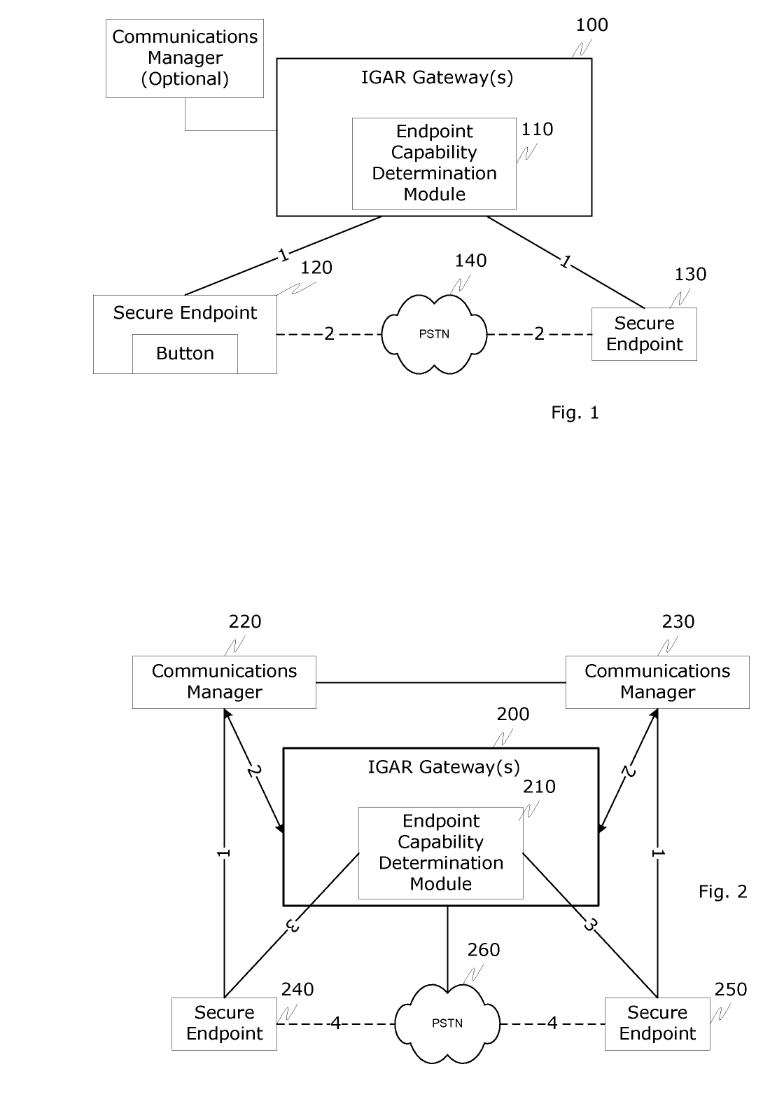

FIG. 1 illustrates an exemplary communications environment according to this invention. In addition to well known componentry, the communications environment includes one or more IGAR gateways 100, an endpoint capability determination module 110, one or more secure endpoints 120 and 130, such as secure terminal equipment (STE) and a network 140, such as a public switched telephone network. The exemplary communications environment may also include an optional communications manager. In general, one communications manager typically controls a set of gateways, while a second communications manager instance controls an independent set of gateways.

In operation, a communications link is established between, for example, a call origination secure endpoint 120 and an IGAR gateway 100. The IGAR gateway 100 detects a request for a secure call originating from the secure endpoint 120. Upon detection of this request for a secure call, the IGAR gateway 100, in cooperation with the endpoint capability determination module 110, determines the capabilities of the call originating secure endpoint 120 and optionally the call destination secure endpoint 130 as well. Alternatively, the capabilities of the endpoints can be determined first followed by the detection of a request for a secure call.

For example, this determination can be based on one or more of caller ID information, table lookup, and a signal originating from the secure endpoint 120. For example, when a caller requests a communication to “go secure” the caller can press a button on the secure endpoint 120 with this triggering a signal to the IGAR gateway 100 indicating a secure communication is desired. In conjunction with this signal requesting secure communication, an identifier could be sent to the IGAR gateway 100 indicating that the secure endpoint 120 is not IP-capable and therefore not capable of IP-based secure communications. Additionally, the endpoint capability determination module 110 could send a query to the endpoint(s) to determine capabilities. For example, a packet-based query could be send to the endpoint(s), and if no response received, the endpoint capability determination module 110 assuming the endpoint is not IP capable. Other techniques could also be used and in general any method of determining endpoint capabilities will work with the present invention.

With information regarding the capabilities of the secure endpoint(s), the endpoint capability determination module 110 provides information to the IGAR gateway 100 as to whether the endpoint(s) are IP capable. If one or more of the secure endpoints is not IP-capable, the communication is forced to be routed using forced IGAR (traditional TDM). The call is then completed between the secure endpoint 120 and the secure endpoint 130.

Alternatively, if the secure endpoints are IP-capable, the communication is completed using VOIP routing.

FIG. 2 illustrates a second exemplary embodiment that includes multiple communication managers 220 and 230 in communication with a common IP link between separate IGAR gateways 200 being controlled by separate instances of CM. Similar to FIG. 1, IGAR gateway 200 includes an endpoint capability determination module 210 and the communications environment also includes secure endpoints 240 and 250 as well as a PSTN 260.

In operation, the IGAR gateway 200 supports a plurality of communications managers, herein the communications manager 220 and the communications manager 230 such that an incoming PSTN call based on the Destination Number and, once answered, in-band digits are passed from the originating PBX to the destination PBX in order to route the call within the answering PBX.

Similar to the operation described above in relation to FIG. 1, the IGAR gateway 200 will signal an inter-PN route via TDM on the same communication manager instance, or between the communication manager instances 220 and 230 by using the endpoint capability determination module 210. Therefore, an inbound IGAR call will notify its respective communication manager that a secure call is desired but the secure call needs to be routed using TDM resources and to not route the call over IP on the forward hops, e.g., downstream communications, between port networks or gateways.

Thus, and similar to FIG. 1, secure endpoint 240 is connected via PSTN 260 to secure endpoint 250 for secure communications.

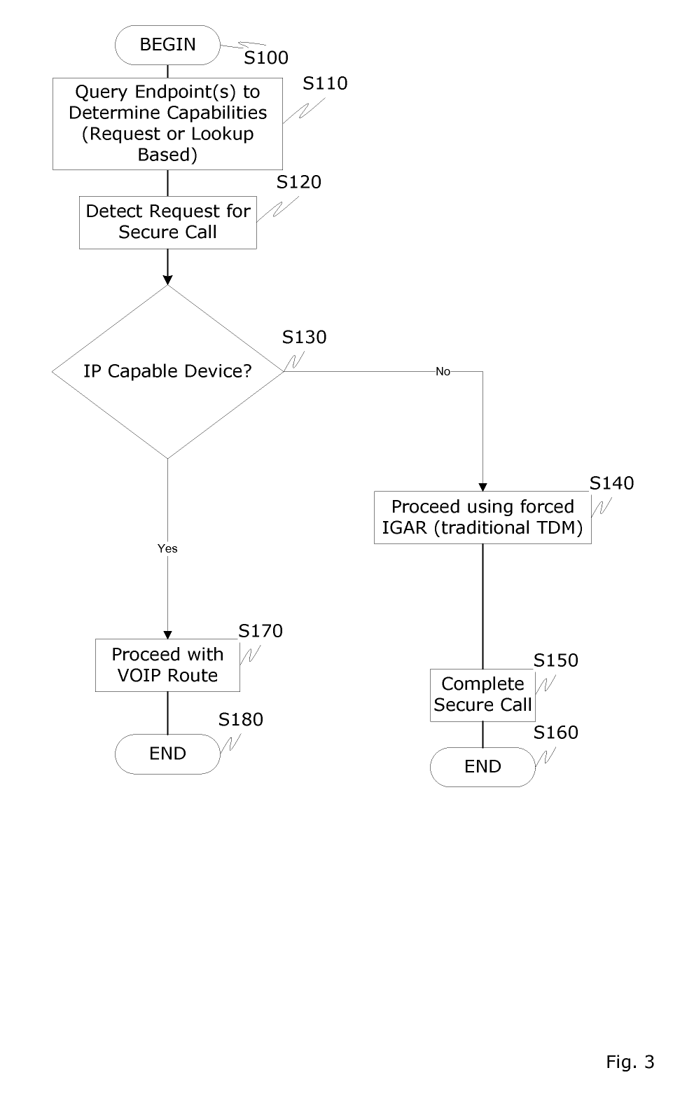

FIG. 3 outlines an exemplary method for forced routing of secure calls according to this invention. In particular, control begins at step S100 and continues to step S110. In step S110, the endpoint(s) are queried to determine their capabilities. Specifically, one or more of the endpoints are queried to determine whether they are IP-capable based on one or more of caller ID information, lookup table information and a signal associated with the endpoint. Then, in step S120, a request for a secure call is detected. Control then continues to step S130.

In step S130, a determination is made whether the endpoint(s) are IP capable. As discussed, this determination is based on the capabilities of the endpoint, and should one or more of the endpoints not be IP-capable, control continues to step S140. In step S140, the communication proceeds using forced IGAR (e.g., traditional TDM). In this instance, the communication is not routed over the IP network on the forward hops between port networks or gateways. Next, in step S150, the secure call is completed with control continuing to step S160 where the control sequence ends.

Alternatively, if it is determined that the endpoints are IP-capable, control jumps to step S170 where the communication proceeds using a VOIP route. Control then continues to step S180 where the control sequence ends.

A number of variations and modifications of the invention can be used. It would be possible to provide or claims for some features of the invention without providing or claiming others.

The exemplary systems and methods of this invention have been described in relation to secure call management. However, to avoid unnecessarily obscuring the present invention, the description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show various components of the system co-located, certain components of the system can be located remotely, at distant portions of a distributed network, such as a LAN, cable network, and/or the Internet, or within a dedicated system. Thus, it should be appreciated, that the components of the system can be combined in to one or more devices, such as a gateway, or collocated on a particular node of a distributed network, such as an analog and/or digital communications network, a packet-switch network, a circuit-switched network or a cable network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, a cable provider, enterprise system, in one or more communications devices, at one or more users' premises, or some combination thereof. Similarly, one or more functional portions of the system could be distributed between a communications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention.

Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A secure communication management method comprising:
determining capabilities of one or more endpoints; and
based on the determining step, forcing routing of a secure communication over PSTN by using IGAR (Inter-Gateway Alternate Routing).

2. The method of claim 1, further comprising one or more of querying one or more of the one or more endpoints, looking-up a caller-ID number of one or more of the one or more endpoints and receiving information from one or more of the one or more endpoints.

3. The method of claim 1, further comprising receiving a request for the secure communication from an endpoint.

4. The method of claim 1, further comprising establishing secure communications between two endpoints over a PSTN.

5. The method of claim 1, wherein two separate instances of an IGAR gateway communicate via two separate instances of communications managers.

6. The method of claim 1, wherein one of the one or more endpoints is a legacy phone.

7. The method of claim 1, further comprising receiving a request for the secure communication from an endpoint based after a user has selected a button on the endpoint.

8. The method of claim 1, wherein, when the secure communication is routed over the PSTN, the secure communication does not use IP for forward hops between port networks or gateways.

9. The method of claim 1, wherein the one or more endpoints are Secure Terminal Equipment (STE).

10. The method of claim 1, further comprising receiving information from an endpoint that indicates the endpoint does not have IP capabilities.

11. A secure communication system comprising:
an endpoint capability determination module that determines capabilities of one or more endpoints, and, in conjunction with an IGAR (Inter-Gateway Alternate Routing) gateway, forces routing of a secure communication over a PSTN.

12. The system of claim 11, wherein the endpoint capability determination module further queries one or more of the one or more endpoints, looks-up a caller-ID number of one or more of the one or more endpoints and receives information from one or more of the one or more endpoints.

13. The system of claim 11, wherein the endpoint capability determination module receives a request for the secure communication from an endpoint.

14. The system of claim 11, wherein a secure communication is established between two endpoints over a PSTN.

15. The system of claim 11, wherein two IGAR gateways connect two communications managers.

16. The system of claim 11, wherein one of the one or more endpoints is a legacy phone.

17. The system of claim 11, further comprising a button, that when selected, sends a request for the secure communication from an endpoint.

18. The system of claim 11, wherein when the secure communication is routed over the PSTN, the secure communication does not use IP for forward hops between port networks or gateways.

19. The system of claim 11, wherein the one or more endpoints are Secure Terminal Equipment (STE).

20. One or more of means and a computer-readable storage media having stored thereon instructions that when executed, perform the steps in claim 1.
